(19) United States
(12) Patent Application Publication
(10) Pub. No.: US 2010/0101513 A1
(43) Pub. Date: Apr. 29, 2010

(54) Radiator Apparatus For Vehicle

(75) Inventor: Hong Suk CHANG, Gyunggi-Do (KR)

Correspondence Address: MORGAN, LEWIS & BOCKIUS LLP (SF), One Market, Spear Street Tower, Suite 2800, San Francisco, CA, 94105, US

(73) Assignees: Hyundai Motor Company, Seoul (KR); Kia Motors Corporation, Seoul (KR)

(21) Appl. No.: 12/327,591

(22) Filed: Dec. 3, 2008

(30) Foreign Application Priority Data
Oct. 24, 2008 (KR) 10-2008-0104879

(51) Int. Cl. F01P 5/02; F16H 7/12

(52) U.S. Cl. 123/41.49; 474/136

(57) ABSTRACT

A radiator apparatus for a vehicle may include a power transmitting mechanism configured to receive rotational force of an engine pulley and rotating a cooling fan thereby, and a driving belt tension maintaining device disposed between the power transmitting mechanism and the engine pulley and adjusting a relative distance therebetween to maintain tension of a driving belt sufficiently enough to transfer the rotation force of the engine pulley to the power transmitting mechanism, wherein the driving belt couples the power transmitting mechanism and the engine pulley.

### CROSS-REFERENCE TO RELATED APPLICATION

The present application claims to priority to Korean Patent Application Number 10-2008-0104879 filed Oct. 24, 2008, the entire contents of which application is incorporated herein for all purposes by this reference.

### BACKGROUND OF THE INVENTION

1. Field of the Invention

The present invention relates to a radiator apparatus for a vehicle and, more particularly, to a radiator apparatus for a vehicle, in which a driving belt tension maintaining device is disposed between a power transmitting mechanism and a vehicle body.

2. Description of Related Art

In general, an automobile is driven by injecting a mixed gas of fuel and air into a cylinder of a combustion engine and transmitting explosive force generated in the cylinder to driving wheels. Accordingly, the engine includes a water jacket through which cooling water is circulated to cool the high temperature caused by the explosion. The heated cooling water circulated through the water jacket is discharged to a radiator, circulated through a heat radiating core including a water tube and a fin, cooled by a cooling fan disposed at one side of the radiator, and then returned to the water jacket.

FIG. 1 is a perspective view showing a radiator apparatus for a vehicle in accordance with a conventional art.

Referring to FIG. 1, the radiator apparatus for a vehicle in accordance with a conventional art comprises a radiator 1 disposed at one side of an installation plate 2 and a fan plate 3 disposed at the other side of the installation plate 2.

The radiator 1 includes a heat radiating core in which cooling water is cooled and a frame 1a disposed at the left and right sides of the heat radiating core. The heat radiating core includes a water tube through which cooling water is circulated and a fin for increasing the contact surface of the water tube. An inlet and outlet hose 1b through which cooling water is supplemented is disposed at one side of the frame 1a, an inlet pipe 1c through which cooling water heated by circulating the engine is introduced is disposed at the top of the frame 1a, and an outlet pipe 1d through which cooling water cooled by circulating the heat radiating core is fed to the engine is disposed at the bottom of the frame 1a.

Central portions of the installation plate 2 and the fan plate 3 are opened, and a cooling fan 4 for blowing air to the heat radiating core of the radiator 1 is rotatably disposed at the opened portion. The cooling fan 4 is connected to a fan pulley 4a, the fan pulley 4a is connected to an idle pulley 4c by a fan belt 4b, and the idle pulley 4c is connected to an engine pulley 4e by a driving belt 4d. Accordingly, when the engine pulley 4e is rotated by the driving force of the engine, the idle pulley 4c is rotated by the driving belt 4d. Then, the fan pulley 4a is rotated by the fan belt 4b, and thereby the cooling fan 4 is rotated to blow air to the heat radiating core of the radiator 1. As a result, the cooling water circulated through the inside of the heat radiating core is cooled.

The idle pulley 4c and the fan pulley 4a are rotatably connected to connecting members 4f and 4g, respectively, and the connecting members 4f and 4g are mounted on the fan plate 3 by means of mounting arms 5, respectively.

Moreover, the connecting member 4f to which the idle pulley 4c is rotatably connected is supported to a mounting plate 7 by a damper 8. The damper 8 is a commonly used hydraulic damper. That is, the damper 8 comprises a cylinder 8a and a rod 8b. As the rod 8b moves back and forth into the cylinder 8a by hydraulic pressure of working fluid contained in the cylinder 8a, the damper 8 primarily absorbs vibration of the idle pulley 4c to reduce the vibration transmitted to the radiator 1.

Furthermore, a mounting bracket 6 for fixing the fan plate 3 to a vehicle body is disposed at the top of the fan plate 3, a damper 6a is disposed between the mounting bracket 6 and the fan plate 3, and a bush 7a is disposed between the mounting plate 7 and the fan plate 3.

However, in the radiator apparatus for a vehicle in accordance with the conventional art, since the tension of the driving belt 4d varies according to a change in the ambient temperature, it is necessary to adjust the tension of the driving belt 4d, which results in difficulties in moving the top of the radiator 1 farther away from the engine pulley 4e by adjusting the mounting bracket 6 and the damper 6a. At this time, the bush 7a disposed at the bottom of the radiator 1 is inclined to one side, and thus it does not stably support the radiator 1.

Moreover, since the idle pulley 4c and the fan pulley 4a, which receive the rotational force from the engine pulley 4e and rotate the cooling fan 4, are connected to the radiator 1, the vibration of the engine is transmitted to the vehicle interior, thus deteriorating ride comfort.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a radiator apparatus for a vehicle, which can maintain the tension of a driving belt without moving a radiator and, at the same time, prevent vibration of an engine from being transmitted to the vehicle interior through the radiator.

In an aspect of the present invention, a radiator apparatus for a vehicle may include a power transmitting mechanism configured to receive rotational force of an engine pulley and rotating a cooling fan thereby, and a driving belt tension maintaining device disposed between the power transmitting mechanism and the engine pulley and adjusting a relative distance therebetween to maintain tension of a driving belt sufficiently enough to transfer the rotation force of the engine pulley to the power transmitting mechanism, wherein the driving belt couples the power transmitting mechanism and the engine pulley.

The driving belt tension maintaining device may include a damper coupling the driving belt tension maintaining device and the vehicle body.

The power transmitting mechanism may include a fan pulley coupled to the cooling fan, and an idle pulley coupled to the fan pulley by a fan belt and coupled to the engine pulley by the driving belt to transmit the rotational force of the engine pulley to the fan pulley.

The idle pulley may be disposed higher than the fan pulley and the engine pulley.

The idle pulley may be coupled to a damper connected to a vehicle body.

The driving belt tension maintaining device may include a rotating member, one end of which is rotatably connected to the fan pulley and the other end of which is rotatably connected to the idle pulley.

The driving belt tension maintaining device may further include a damper connecting the other end of the rotating member and a vehicle body.

The damper may be hinge-connected to the rotating member and the vehicle body respectively.

The damper may include a cylinder and a rod slidably coupled to the cylinder.

A fan belt tension adjusting device may be disposed on the other end of the rotating member and configured to adjust position of the idle pulley in a radial direction of the fan pulley.

The rotating member may include a body, a through hole formed on a first end of the body and through which an axis of the fan pulley passes and is coupled thereto, and a slot formed on a second end of the body and through which an axis of the idle pulley passes and is coupled thereto.

The through hole may have a circular shape and the slot has an oval shape extending in longitudinal direction of the rotating member.

A fan belt tension adjusting device may be disposed on the other end of the rotating member and configured to adjust position of the idle pulley in a radial direction of the fan pulley, the fan belt tension adjusting device including a fixing bracket fixed to the second end of the body of the rotating member, and a moving bracket slidably coupled to the body of the rotating member and coupled to the fixing bracket wherein the moving bracket is configured to be relatively moveable from and to the fixing member, the moving bracket including a fixing hole through which the axis of the idle pulley passes so that the fixing hole of the moving bracket and the slot of the rotating member are coupled together and thus the moving bracket is slidably movable along the slot of the rotating member.

The power transmitting mechanism may be disposed to be spaced apart from a radiator with a predetermined distance.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a perspective view showing a conventional radiator apparatus for a vehicle.

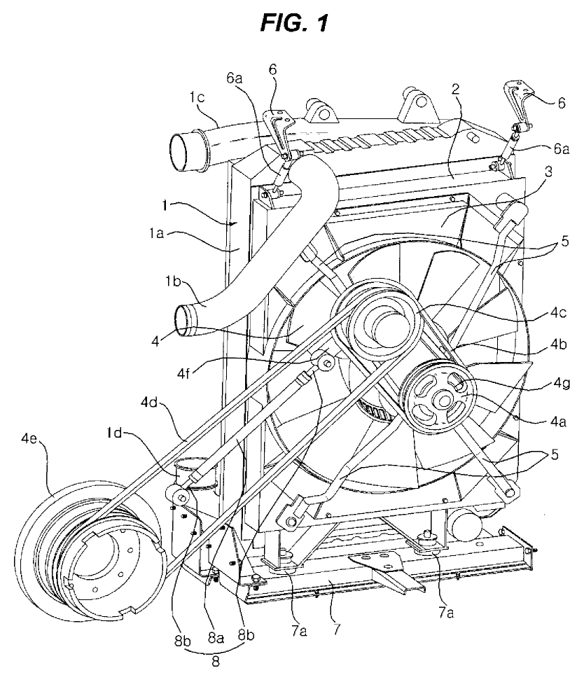

FIG. 2 is a perspective view showing an exemplary radiator apparatus for a vehicle in accordance with the present invention.

FIG. 3 is a side view showing the radiator apparatus for a vehicle in accordance with the present invention.

FIG. 4 is a schematic diagram of main parts of the radiator apparatus for a vehicle in accordance with the present invention of FIG. 2.

FIG. 5 is a detailed diagram of an exemplary driving belt tension maintaining device of FIG. 4.

FIG. 6 is a detailed diagram of an exemplary fan belt tension adjusting device of FIG. 5.

### DETAILED DESCRIPTION OF THE PRESENT INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

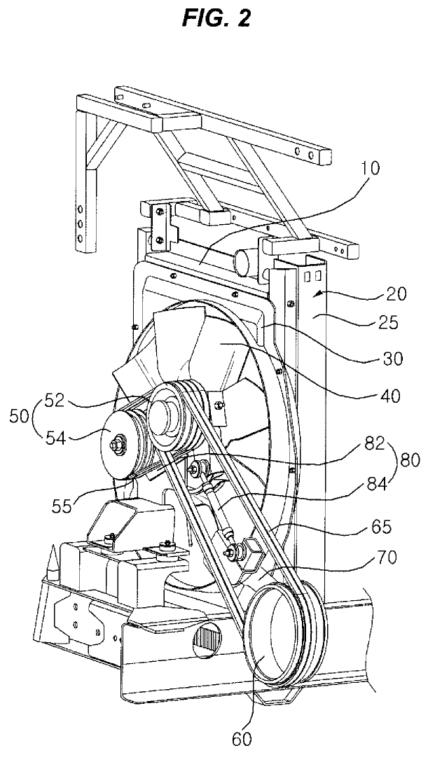

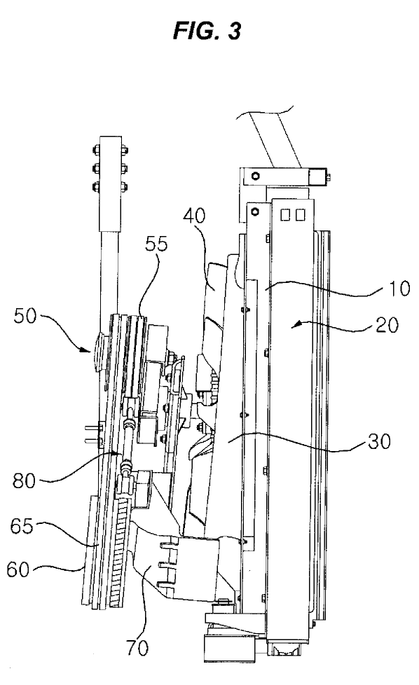

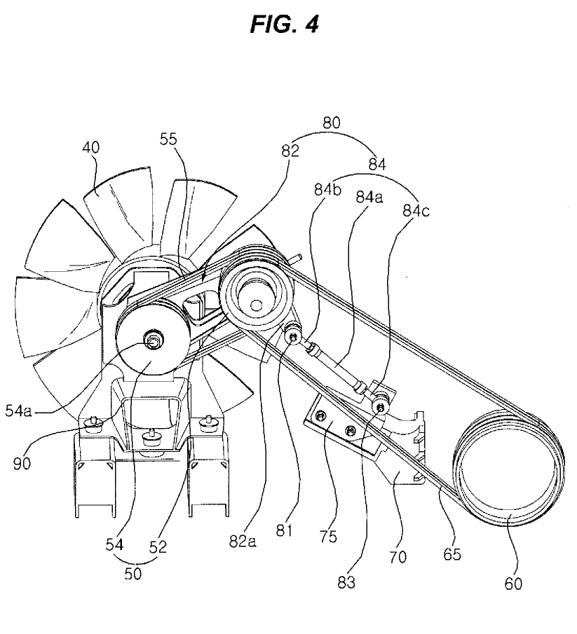

FIG. 2 is a perspective view showing a radiator apparatus for a vehicle in accordance with the present invention, FIG. 3 is a side view showing a radiator apparatus for a vehicle in accordance with the present invention, and FIG. 4 is a schematic diagram of main parts of the radiator apparatus for a vehicle in accordance with the present invention of FIG. 2.

Referring to FIGS. 2 to 4, the radiator apparatus for a vehicle in accordance with various embodiments of the present invention comprises a radiator 20 disposed at one side of an installation plate 10 and a fan plate 30 disposed at the other side of the installation plate 10.

The radiator 20 includes a heat radiating core in which cooling water is cooled and a frame 25 disposed at the left and right sides of the heat radiating core. The heat radiating core includes a water tube through which cooling water is circulated and a fin for increasing the contact surface of the water tube.

Central portions of the installation plate 10 and the fan plate 30 are opened, and a cooling fan 40 for blowing air to the heat radiating core of the radiator 20 is rotatably disposed at the opened portion.

The cooling fan 40 is disposed to be spaced apart from the radiator 20 and connected to a power transmitting mechanism 50, and the power transmitting mechanism 50 receives rotational force from an engine pulley 60 and rotates the cooling fan 40.

The power transmitting mechanism 50 comprises an idle pulley 52 connected to the engine pulley 60 by a driving belt 65 and a fan pulley 54 connected to the idle pulley 52 by a fan belt 55 and rotating the cooling fan 40. Accordingly, when the engine pulley 60 connected to an engine is rotated by the driving force of the engine, the idle pulley 52 is rotated by the driving belt 65. Then, the fan pulley 54 is rotated by the fan belt 55, and thereby the cooling fan 40 is rotated to blow air to the heat radiating core of the radiator 20. As a result, the cooling water circulated through the inside of the heat radiating core is cooled.

Moreover, a driving belt tension maintaining device 80, which maintains the tension of the driving belt 65 connecting the power transmitting mechanism 50 and the engine pulley 60, is disposed on the power transmitting mechanism 50.

The driving belt tension maintaining device 80 comprises a rotating member 82 rotatably connected to the power transmitting mechanism 50 and a damper 84 connected between the rotating member 82 and the vehicle body 70 to maintain the tension of the driving belt 65 by adjusting length of the rotating member 82.

The rotating member 82 is rotatably coupled to an axis 54a of the fan pulley 54.

The damper 84 comprises a cylinder 84a, and rods 84b and 84c, which are respectively disposed at both ends of the cylinder 84a so as to move back and forth into the cylinder 84a and respectively connected to the rotating member 82 and the vehicle body 70.

In more detail, the rotating member 82 includes a bracket 82a disposed adjacent to the idle pulley 52, and the rod 84b disposed toward the rotation member 82 is connected to the bracket 82a by a hinge 81 and connected to the rotating member 82. Moreover, a bracket 75 is also disposed on the vehicle body 70, and the rod 84c disposed toward the vehicle body 70 is connected to the bracket 75 by a hinge 83 and connected to the vehicle 70.

In order to prevent vibration of an engine from being transmitted to the vehicle interior through the radiator 20, as shown in FIG. 3, the power transmitting mechanism 50 is not connected to the radiator 20, but connected to the vehicle body 70 by the driving belt tension maintaining device 80 and support member 90.

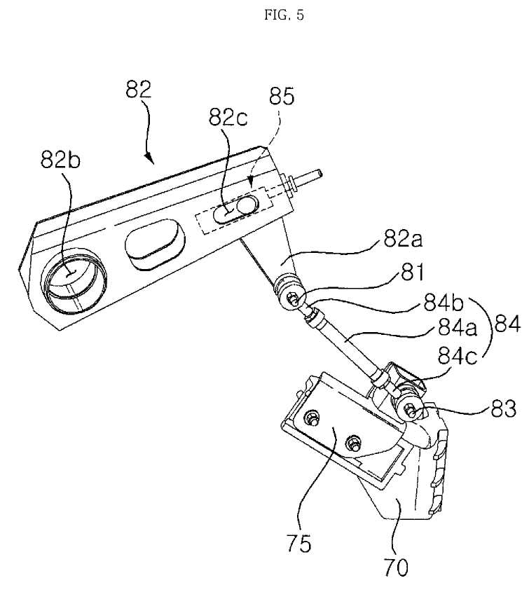

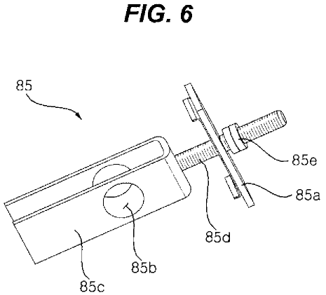

FIG. 5 is a detailed diagram of the driving belt tension maintaining device of FIG. 4, and FIG. 6 is a detailed diagram of a fan belt tension adjusting device of FIG. 5.

Referring to FIGS. 4 to 6, the rotating member 82 includes a through hole 82b through which the axis 54a of the fan pulley 54 passes and a slot 82c through which an axis of the idle pulley 52 passes.

The through hole 82b has a circular shape and the slot 82c has an oval shape extending in the longitudinal direction of the rotating member 82.

The through hole 82b is formed to be larger than the axis 54a of the fan pulley 54 so that the axis 54a of the fan pulley 54 can rotate, and the slot 82c is formed to be larger than the axis of the idle pulley 52 so that the axis of the idle pulley 52 can rotate through the slot 82c and move along the slot 82c.

In this configuration, as the engine pulley 60 rotates in the clockwise direction in FIG. 4, the rotating member 82 coupling the fan pulley 54 and the idle pulley 50 is biased in the counterclockwise direction with respect to the axis 54a of the fan pulley 54 and thus pulls the damper 84. Accordingly, the damper 84 can function to maintain a tension between the idle pulley 52 and the engine pulley 60 and absorb the vibration of the idle pulley 52.

Moreover, a fan belt tension adjusting device 85 for adjusting the tension of the fan belt 55 coupling the fan pulley 54 and the idle pulley 52 by moving position of the idle pulley 52 is disposed on one end of the rotating member 82.

The fan belt tension adjusting device 85 is slidably inserted into the one end of the rotating member 82 and configured to adjust the relative distance between the fan pulley 54 and the idle pulley 52 as explained hereinafter.

The fan belt tension adjusting device 85 comprises a fixing bracket 85a fixed at one side of the one end of the rotating member 82, and a moving bracket 85c slidably inserted into the one end of the rotating member 82. The moving bracket 82c is screw-connected to the fixing bracket 85a and includes a fixing hole 85b through which the axis of the idle pulley 52 passes through the slot 82c and is coupled thereto.

A screw shaft 85d projects from one side of the moving bracket 85c, and a screw groove is formed on the outer circumferential surface of the screw shaft 85d. The screw shaft 85d is inserted and connected to the fixing bracket 85a and then engaged with a nut 85e. When the nut 85e is rotated, the moving bracket 85c is moved in the longitudinal direction of the rotating member 82 within a gap between the axis of the idle pulley 52, which is inserted into the slot 82c, and the slot 82c, and thus the axis of the idle pulley 52 connected to the moving bracket 85c is moved in the longitudinal direction of the rotating member 82, thereby adjusting the tension of the fan belt 55.

The operation of the radiator apparatus for a vehicle having the above configuration in accordance with various embodiments of the present invention will be described below.

If the temperature of the engine room is increased or the engine is shaken by the operation of the engine, the tension of the driving belt 65 may be loosen. In this case, if the engine pulley 60 rotates in the clockwise direction, the idle pulley 52 moves upwards so that the rods 84b and 84c of the damper 84 are drawn from the inside of the cylinder 84a. As a result, the relative distance between the idle pulley 52 and the engine pulley 60 is automatically adjusted and the sufficient tension of the driving belt 65 is maintained.

In contrast, if the temperature of the engine room is decreased, the tension of the driving belt 65 may be increased. In this case, the idle pulley 52 moves downwards so that the rods 84b and 84c of the damper 84 are pushed into the cylinder 84a. As a result, the relative distance between the idle pulley 52 and the engine pulley 60 is automatically adjusted and the sufficient tension of the driving belt 65 is maintained.

To increase an efficiency of tension adjustment of the driving belt 65, an elastic member may be coupled to the idle pulley 52.

Moreover, it is possible to manually adjust the tension of the fan belt 55 by rotating the nut 85e of the fan belt tension adjusting device 85 to move the moving bracket 85c in the longitudinal direction of the rotating member 82.

As described above, the radiator apparatus for a vehicle has the following effects. First, since the damper rotates the rotating member rotatably connected to the power transmitting mechanism, it is possible to maintain the tension of the driving belt, even if the tension of the driving belt varies according to a change in the ambient temperature.

Moreover, since the power transmitting mechanism is disposed to be spaced apart from the radiator, it is possible to prevent the vibration of the engine from being transmitted to the vehicle interior through the radiator.

For convenience in explanation and accurate definition in the appended claims, the terms “inside” and “interior” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A radiator apparatus for a vehicle, comprising:
a power transmitting mechanism configured to receive rotational force of an engine pulley and rotating a cooling fan thereby; and
a driving belt tension maintaining device disposed between the power transmitting mechanism and the engine pulley and adjusting a relative distance therebetween to maintain tension of a driving belt sufficiently enough to transfer the rotation force of the engine pulley to the power transmitting mechanism, wherein the driving belt couples the power transmitting mechanism and the engine pulley.

2. The radiator apparatus for a vehicle of claim 1, wherein the driving belt tension maintaining device includes a damper coupling the driving belt tension maintaining device and a vehicle body.

3. The radiator apparatus for a vehicle of claim 1, wherein the power transmitting mechanism comprises:
a fan pulley coupled to the cooling fan and supported on a vehicle body; and
an idle pulley coupled to the fan pulley by a fan belt and coupled to the engine pulley by the driving belt to transmit the rotational force of the engine pulley to the fan pulley.

4. The radiator apparatus for a vehicle of claim 3, wherein the idle pulley is disposed higher than the fan pulley and the engine pulley.

5. The radiator apparatus for a vehicle of claim 4, wherein the idle pulley is coupled to a damper connected to a vehicle body.

6. The radiator apparatus for a vehicle of claim 3, wherein the driving belt tension maintaining device comprises a rotating member, one end of which is rotatably connected to the fan pulley and the other end of which is rotatably connected to the idle pulley.

7. The radiator apparatus for a vehicle of claim 6, wherein the driving belt tension maintaining device further includes a damper, one end of which is connected to the other end of the rotating member and the other end of which is connected to a vehicle body.

8. The radiator apparatus for a vehicle of claim 7, wherein the damper is hinge-connected to the rotating member and the vehicle body respectively.

9. The radiator apparatus for a vehicle of claim 8, wherein the damper comprises a cylinder and a rod slidably coupled to the cylinder.

10. The radiator apparatus for a vehicle of claim 6, wherein a fan belt tension adjusting device is disposed on the other end of the rotating member and configured to adjust position of the idle pulley in a radial direction of the fan pulley.

11. The radiator apparatus for a vehicle of claim 6, wherein the rotating member comprises:
a body;
a through hole formed on a first end of the body and through which an axis of the fan pulley passes and is coupled thereto; and
a slot formed on a second end of the body and through which an axis of the idle pulley passes and is coupled thereto.

12. The radiator apparatus for a vehicle of claim 11, wherein the through hole has a circular shape and the slot has an oval shape extending in longitudinal direction of the rotating member.

13. The radiator apparatus for a vehicle of claim 11, wherein a fan belt tension adjusting device is disposed on the other end of the rotating member and configured to adjust position of the idle pulley in a radial direction of the fan pulley, the fan belt tension adjusting device comprising:
a fixing bracket fixed to the second end of the body of the rotating member; and
a moving bracket slidably coupled to the body of the rotating member and coupled to the fixing bracket wherein the moving bracket is configured to be relatively moveable from and to the fixing member, the moving bracket including a fixing hole through which the axis of the idle pulley passes so that the fixing hole of the moving bracket and the slot of the rotating member are coupled together and thus the moving bracket is slidably movable along the slot of the rotating member.

14. The radiator apparatus for a vehicle of claim 1, wherein the power transmitting mechanism is disposed to be spaced apart from a radiator with a predetermined distance.

15. A vehicle comprising the radiator apparatus of claim 1.
